(19) United States
(12) Patent Application Publication
(10) Pub. No.: US 2006/0235866 A1
(43) Pub. Date: Oct. 19, 2006

(54) Method and apparatus for enabling enhanced navigation data associated with contents recorded on a recording medium to be utilized from a portable storage

(76) Inventor: Sung Wan Park, Suwon-si (KR)

Correspondence Address: HARNESS, DICKEY & PIERCE, P.L.C., P.O. BOX 8910, RESTON, VA, 20195, US

(21) Appl. No.: 11/339,473

(22) Filed: Jan. 26, 2006

(30) Foreign Application Priority Data
Jan. 31, 2005 (KR) 10-2005-0008502
Mar. 14, 2005 (KR) 10-2005-0020912

(51) Int. Cl. G06F 17/00

(52) U.S. Cl. 707/101

(57) ABSTRACT

The present invention relates to a method and an apparatus for reproducing content on interactive DVD by using a portable storage. The enhanced navigation data designated for interactive playback of content recorded in a recording medium is received from a server connected to a network. When the received enhanced navigation data are stored in an auxiliary storage such as USB memory removable from playback apparatuses, the content of the recording medium and the enhanced navigation data of the auxiliary storage are made associated with each other by recording information for linking the enhanced navigation data with the content additionally into the auxiliary storage.

### CROSS-REFERENCE TO RELATED PATENT APPLICATION

This application claims the benefit of Korean Patent Application Nos. 10-2005-0008502, filed on Jan. 31, 2005 and 10-2005-0020912, filed on Mar. 14, 2005, in the Korean Intellectual Property Office, the disclosure of which is incorporated herein in its entirety by reference.

### BACKGROUND

1. Field

This document relates to a method and an apparatus for reproducing content on a recording medium such as interactive DVD by using a portable storage.

2. Description of the Related Art

A storage medium containing a large amount of digital data such as DVD has a very high recording capacity. DVD is a high capacity recording medium and provides a large space for data storage, capable of recording high quality video data as well as high quality audio data extending over many hours.

DVD provides two recording areas: one is designated for recording actual data (namely, video or A/V data), whereas the other one is designated to record control or navigation data needed for playback control of the recorded actual data.

When DVD is inserted and loaded successfully into a DVD playback apparatus, the navigation data are first read out and stored into memory within the apparatus; subsequently, with reference to the commands or control information contained in the navigation data, the actual data (A/V data) are reproduced. Accordingly, the user, by using the DVD playback apparatus, can watch high quality video recorded in DVD.

Recently, an interactive or enhanced navigation system has been proposed (namely, I-DVD or ENAV (Enhanced Navigation)). An interactive content disc such as I-DVD or ENAV disc can contain control, navigation, or enhanced A/V data in the form of HTML (Hyper-Text Markup Language) or XML (Extensible Markup Language) file. The control or navigation data serve for an interactive playback apparatus (namely, I-DVD or ENAV disc player) to reproduce main A/V data recorded in the interactive disc along with additional auxiliary data such as scenes or actors' narratives.

The aforementioned navigation data are called as enhanced or additional navigation data; the additional (enhanced) navigation data, together with main A/V data, can be recorded in a content disc in the form of playback-only data or provided from a remote server through a network.

Accordingly, a player reproducing the interactive disc, before reproducing content on a loaded disc or during playback of the content, receives enhanced navigation data associated with the content from a server; the player then stores the enhanced navigation data in a fixed internal storage such as hard disk or memory, thereby reproducing the content on the interactive disc according to the enhanced navigation data.

However, although the user has completely downloaded enhanced navigation data and utilized them at a certain player, when the user changes his location and tries to play again the interactive disc of the same content by loading the disc into another player, the user must receive the enhanced navigation data associated with the content once more.

On the other hand, since enhanced navigation data cannot be downloaded when the player is disconnected from a network, enhanced presentation function (provided from the enhanced navigation data) for the content recorded in the disc becomes unavailable. Even if the player is connected to a network, time is needed to receive again necessary enhanced navigation data from the network.

The situation above is very annoying to the user who moves frequently and thus changes places where an interactive disc is reproduced.

### SUMMARY OF THE INVENTION

The present invention is directed to provide a means for storing enhanced navigation data of A/V content recorded in a recording medium into a portable storage and enabling the enhanced navigation data to be utilized further.

A method according to one embodiment of the present invention receives enhanced navigation data designated for interactive playback of content recorded in a recording medium from a server connected to a network. The received enhanced navigation data are stored in an auxiliary storage removable from a playback apparatus, and by storing information for linking the enhanced navigation data with the content recorded in the recording medium, the content of the recording medium and the enhanced navigation data of the storage apparatus are associated with each other.

In one embodiment of the present invention, the information for linking with the content is recorded in the form of a file structure based on identifying information of the content.

In one embodiment of the present invention, the information for linking with the content is recorded by a directory structure and directory names.

In another embodiment of the present invention, the information for linking with the content is recorded by file names.

In another embodiment of the present invention, the information for linking with the content is composed of identifying information of the content and inserted into enhanced navigation data and recorded therein.

In one embodiment of the present invention, the information for linking with the content is composed of the information stored in a recording medium wherein the content is recorded.

In another embodiment of the present invention, the information for linking with the content is made up based on the information received from a server connected to a network.

Also, in another embodiment of the present invention, after confirming identifying information of content (IIoC) recorded in a recording medium and checking whether enhanced navigation data associated with the confirmed identifying information are stored in an auxiliary storage removable from a playback apparatus, the content, if found stored, is reproduced based on the enhanced navigation data recorded in the auxiliary storage.

In one embodiment of the present invention, identifying information of the content is composed of content provider ID of the content and content ID (CID) which the provider has assigned uniquely to the content.

In one embodiment of the present invention, the content provider ID is the name of the provider, and the content ID is the title of the content.

In one embodiment of the present invention, enhanced navigation data downloaded from a server connected to a network are stored into the removable auxiliary storage such as USB memory.

In another embodiment of the present invention, the downloaded enhanced navigation data are stored in a storage fixed to a playback apparatus and the stored enhanced navigation data are duplicated and recorded in the auxiliary storage.

In one embodiment of the present invention, the content ID is recorded additionally for respective objects which make up enhanced navigation data stored in the auxiliary storage.

### BRIEF DESCRIPTION OF THE DRAWINGS

The accompanying drawings, which are included to provide a further understanding of the invention, illustrate the preferred embodiments of the invention, and together with the description, serve to explain the principles of the present invention.

In the drawings:

FIG. 1 illustrates the structure of the interactive disc player according to the present invention;

FIG. 2 illustrates an exemplary structure of identifying information of content enabling unique identification of content, included in the navigation data of a recording medium containing the content;

FIG. 3 illustrates another embodiment of the structure of identifying information of content according to the present invention;

FIG. 4 illustrates an embodiment according to the present invention, wherein enhanced navigation data and identifying information of content are stored together in a removable auxiliary memory; and

FIG. 5 illustrates a playback procedure according to the present invention, wherein content is reproduced at another player by using a removable auxiliary memory wherein enhanced navigation data are stored together with identifying information of associated content.

### DETAILED DESCRIPTION OF THE EMBODIMENTS

Hereinafter, according to the present invention, preferred embodiments of a method and an apparatus which enables enhanced navigation data associated with content recorded in a recording medium to be utilized from a portable storage will be described in detail with reference to appended drawings.

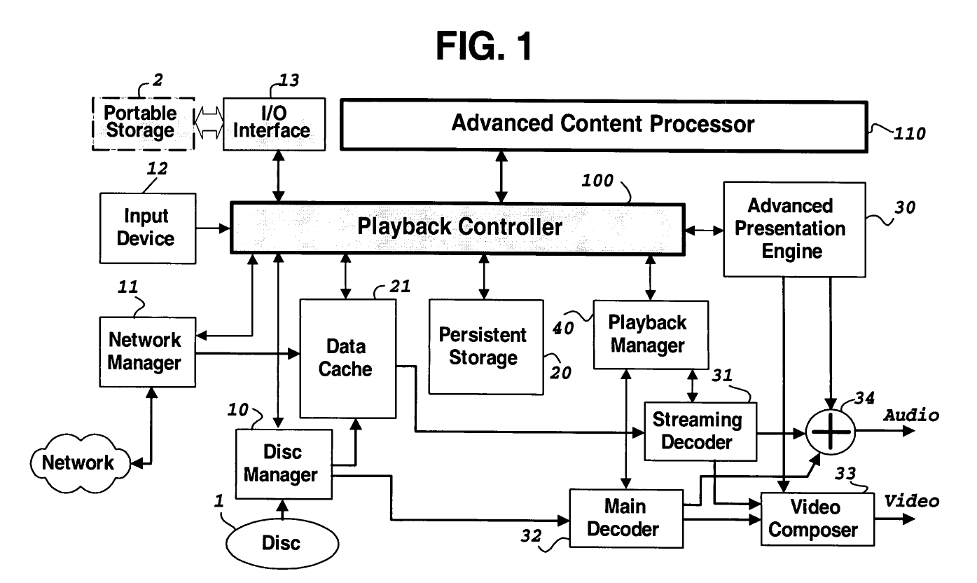

FIG. 1 illustrates the structure of an interactive disc player according to the present invention. The player shown in FIG. 1 includes disc manager 10 which drives a disc 1 and reads the data recorded therein; network manager 11 which is connected to the Internet or a home network and exchanges data with the network; input device 12 which manages inputs from the user or external devices; I/O interface 13 which connects to and communicates with an external device such as USB memory; persistent storage 20 where the data required for playback are stored on loading the disc 1 and the stored data are retained until withdrawal of the disc; data cache 21 where necessary data at each instant of playback are stored or renewed; main decoder 32 which decodes main content data reproduced from the disc 1 and produces video and audio signals; streaming decoder 31 which decodes A/V streaming data provided from an external network; advanced presentation engine 30 which produces presentation outputs by using graphic data, sound effects, and/or enhanced text data constituting additional content; video composer 33 which composes input video/graphic signals into a single image screen; audio mixer 34 which combines input audio signals and produces synthesized audio signals; playback manager 40 which manages operations for A/V presentation; advanced content processor 110 which interprets additional navigation files and carries out operations according thereto; and playback controller 100 which controls the interactive playback of content by exchanging data with structuring elements and transmitting control data to associated structuring elements.

In order to describe one embodiment of the present invention, it is assumed that as an auxiliary storage, portable (or attachable) USB memory 2 (hereinafter, ‘memory stick’) is connected to the interactive disc player through the I/O interface 13.

The disc 1 loaded into the apparatus of FIG. 1 contains navigation data files which are essential for the playback and/or exploration of A/V content recorded therein. Also recorded in the disc 1 are enhanced navigation data aimed for enhanced presentation of the A/V content such as scenes or actors' narratives; the enhanced navigation data (which are composed of one or more than one file) are stored in the storage 20 by the disc manager 10 and interpreted by the advanced content processor 110. The storage 20 can also store additional object data such as small-sized scenes, sound effects, and so on which make up the enhanced navigation data, whereas the data cache 21 stores temporary objects which become obsolete after single use.

By the way, enhanced navigation data of the latest version providing functions more improved than those of the loaded disc 1 can be received through the network manager 11 from an external network other than the loaded disc 1. The procedure wherein improved enhanced navigation data are obtained from the external network can be carried out autonomously by the player, or carried out upon the request of the user. The improved enhanced navigation data of the latest version include a navigation program specifying additional audio stream (additional languages and producer's comments), additional subtitle such as additional text or graphic; and/or playback scenario of additional or improved content.

On the one hand, even when the disc 1 does not have enhanced navigation data, the enhanced navigation data identified from the content recorded in the disc 1 can also be received from an external network. Linkage of content on the disc 1 with the enhanced navigation data belonging to the server connected to the network (not shown) can be accomplished by using an identification number such as a serial number recorded in the disc 1 or provider ID and content ID.

When the playback controller 100 detects memory stick 2 through the I/O interface 13, by checking whether the memory stick 2 has identifying information of content (as for the identifying information, it will be described in detail hereinafter) recorded on the currently loaded disc 1, the playback controller 100 checks whether enhanced navigation data associated with the content recorded on the disc 1 exists. If the enhanced navigation data does not exist, the playback controller 100 issues a request to the server connected to the external network through the network manager 11, thereby downloading the enhanced navigation data. The enhanced navigation data received from then on is stored in the memory stick 2 other than the persistent storage 20. Storing in this case is achieved by utilizing a file system inside the memory stick 2.

In another embodiment, the downloaded enhanced navigation data can be stored in the persistent storage 20 first, after which they can be duplicated and stored in the memory stick 2.

On the one hand, when enhanced navigation data are stored in the memory stick 2, they are stored along with IIoC, which will be described in detail in the following, or stored under the file structure determined according to the content.

The playback controller 100, before storing of the downloaded enhanced navigation data is started or after storing is completed, records the information, which links the content recorded in the disc 1 and the enhanced navigation data, in the memory stick 2, which will be described in detail in the following.

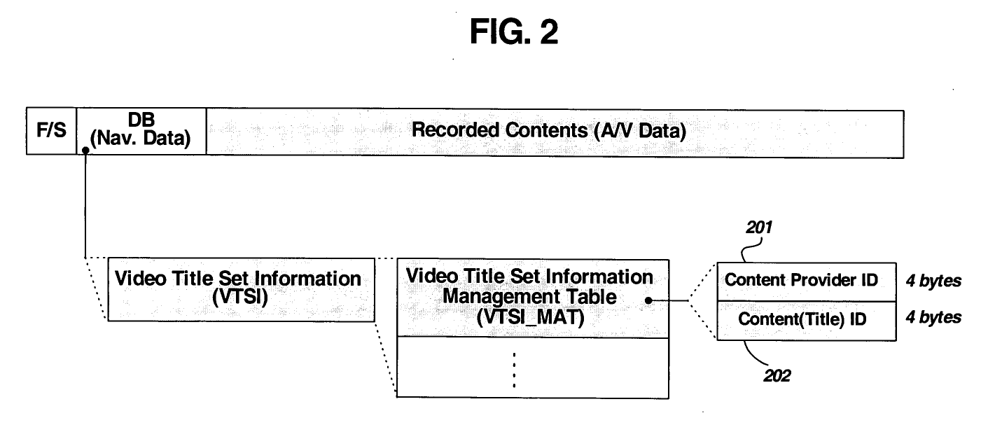

The playback controller 100 reads identifying information of content (IIoC) recorded on the disc 1 from navigation information loaded previously into the persistent storage 20. As shown in FIG. 2, the IIoC is recorded by the size of 8 bytes at video title set information management table (VTSI_MAT) within video title set information (VTSI). The 8 bytes, consisting of content provider ID 201 of 4 bytes and content ID (CID) 202 of 4 bytes, describe the content uniquely by recording an identifying number in each area. A unique identification number assigned by a content provider for the corresponding content is recorded in the CID 202 and an identical CID can be used for different content providers.

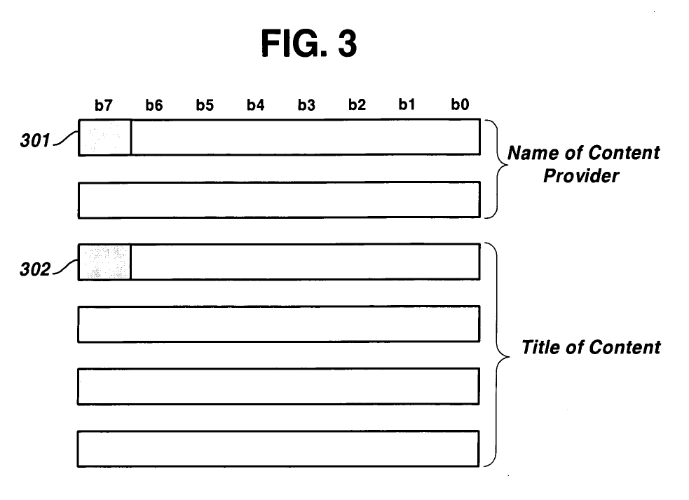

FIG. 3 illustrates another embodiment of the structure of IIoC recorded in the disc 1, consisting of a content provider ID of 16 bytes and content ID of 32 bytes. In this embodiment, a string of ASCII codes such as the name of a content provider and the title of content are recorded in respective IDs; one head byte 301, 302 of each ID records the number of strings recorded in the corresponding field.

The embodiment for the structure of IIoC of the content is for an illustration purpose only and the structure of IIoC can be defined in various ways including the present one.

Also, in another embodiment of the present invention, in addition to the IIoC obtained previously from the disc 1 as shown in FIG. 2 or FIG. 3, the playback controller 100 can obtain detail information about each object constituting the enhanced navigation data (each object can correspond to a file); for example, the playback controller 100 can obtain detail information about media objects such as text, audio and/or video and record them together. The detail information about a media object can be media type, codec needed for decoding the media, language information about text code, and so on.

The detail information is comprehended by the playback controller's 100 requesting the advanced content processor 110 to interpret the downloaded enhanced navigation data; for example, the detail information is comprehended by receiving the information obtained from interpretation of scripts written in XML, SMIL, and so on.

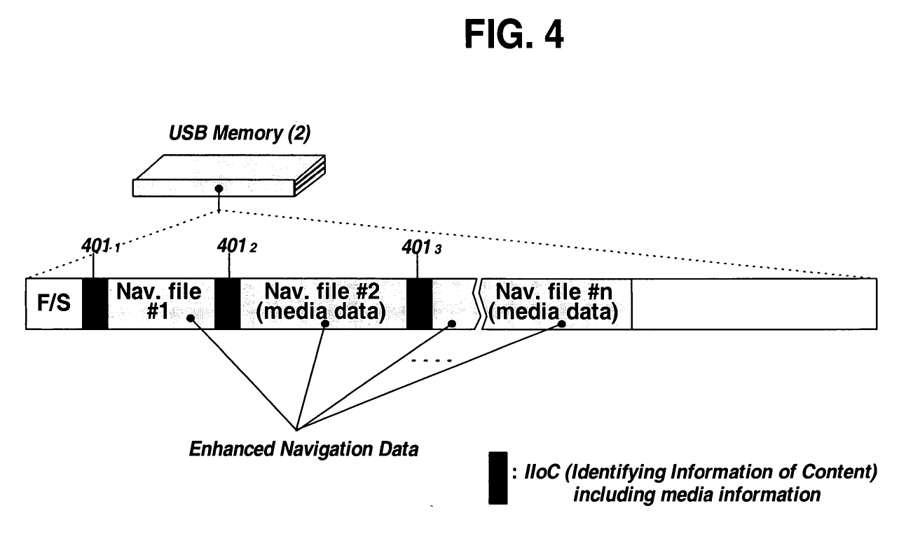

With IIoC and detail information about each object obtained, the playback controller 100, as shown in FIG. 4, appends additional object head information 401n containing the obtained information at the head of each object constituting enhanced navigation data.

Instead of appending IIoC to each object as shown in FIG. 4, a file structure having directory names determined according to the IIoC identified from the loaded disc 1 can be created in a storage area within the memory stick 2, under which enhanced navigation data can be stored without appending IIoC. In this case, the directory having a tree structure and directory names associate the corresponding enhanced navigation data with the content.

For example, when the title of the content recorded in the loaded disc 1 is “Day After Tomorrow” and the name of the provider is “Centropolis Entertainment”, the playback controller 100 creates a directory [Centropolis Entertainment] under a root directory by using the file system in the memory stick 2; [Day After Tomorrow] directory is then created under the directory [Centropolis Entertainment] and downloaded enhanced navigation data are recorded in the [Day After Tomorrow] directory as separate files.

In order for the memory stick 2 to be used for other general purposes, a particular directory for storing enhanced navigation data as in the manner, for example, a directory named as [HD-DVD], is created first at the root directory; a directory named after the content provider is then created under [HD-DVD] directory. Under the directory having the name of the content provider, a directory is created with the name of the content title, under which the enhanced navigation data can be stored as separate files. In other words, from the example, the enhanced navigation data can be stored in the following structure, where *.htm and *.wav files make up the enhanced navigation data.

| | |
|---|---|
| [HD-DVD] | media type |
| [Centropolis Entertainment] | provider name |
| [Day After Tomorrow] | title |
| information.txt | |
| actors_description.htm | |
| korean_language.wav | |
| . . . . . . . | |

An information file (e.g., information.txt) can be included under each created directory. The information file under [HD-DVD] directory provides description about the media of HD-DVD; the information file under [provider name] directory provides description about the corresponding content provider and/or the title provided by the corresponding content provider; and the information file under [title] directory provides general description about the corresponding title.

On the one hand, the storage structure of enhanced navigation data for the content recorded in the loaded disc 1 can be specified by the server which provides the enhanced navigation data, not relying on IIoC recorded in the disc 1. That is to say, when the server transmits requested enhanced navigation data, the server can integrate all the files into a single archived file and within the archived file, specify the directory where each file has to be stored. In this case, when the playback controller 100 decompresses the archived file with the help of the advanced content processor 110, necessary directories are created in the memory stick 2.

As in the foregoing description, instead of implementing the information associated with the content of the loaded disc 1 by using a directory structure and related names, the information can be implemented by utilizing file naming. For example, by specifying a file name in the form of providername_title.extension, the file name can function as link information with content. If multiple files share the same extension (e.g., wav, ac3, htm, etc), the file name can be specified in the form of (provider name)_title_(file identifying information) .extension. In this case, the file identification information can be a serial number or a text which describes the content of the file. A character such as underbar (‘_’) can be used as a delimiter to distinguish provider name, title, and file identification information.

When storing downloaded enhanced navigation data, by creating information for linking with content on the disc with respect to the downloaded enhanced navigation data as described above, in the memory stick 2 is completed, or storing downloaded enhanced navigation data in the memory stick 2 under a directory structure or in the form of file names having information for linking with content is completed, the playback controller 100, upon request from the user, reads the enhanced navigation data through the I/O interface 13 and delivers the enhanced navigation data to the advanced content processor 110. The advanced content processor 110 then interprets the enhanced navigation data and based on the procedures and/or commands specified therein, issues a playback request to the playback controller 100; accordingly, under the control of the playback controller 100, the A/V content on the disc 1 is sequentially fed into the main decoder 32 and decoded content is produced as video and audio signals. At this time, a part of media data of the enhanced navigation data is delivered to the advanced presentation engine 20, where decoded output is presented to the user along with the main A/V content.

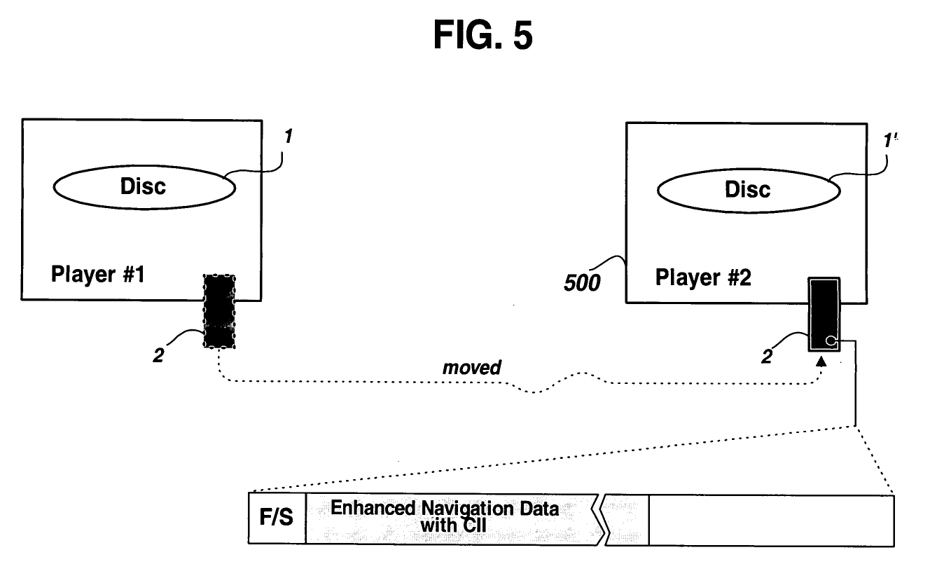

After reproduction in said manner is completed or under the state wherein enhanced navigation data has been downloaded and just stored in the memory stick 2 without playback performed, as shown in FIG. 5, if a user removes the memory stick 2, carries it into another place, connects the memory stick 2 to another interactive disc player (500:Player #2) and issues a request for playback by inserting the disc 1′ where content is recorded, the player 500 searches for video title set information management table (VTSI_MAT) within navigation information on the loaded disc 1′, confirms identifying information of the content having the structure illustrated in FIG. 2 or FIG. 3, and compares the identifying information with the identifying information of content, as shown in FIG. 4, recorded in one or more than one additional object header information 401n within the connected memory stick 2. If the embodiment is found to have a directory structure or file names in accordance with the confirmed identifying information of content, it is checked whether directories or files linked with the identifying information of content are present in the memory stick 2. In an embodiment wherein the directory structure is created based on identifying information of content, when a directory denoting media type, for example, [HD-DVD], is present, the player 500 accesses only the corresponding media directory and directories thereunder.

If the identifying information of content is the same as that in comparison or directory structure or files having the file names in accordance with the confirmed identifying information of content are present, the player 500 decides that enhanced navigation data in the memory stick 2 relates to the content of the loaded disc 1′, instead of carrying out operations for downloading enhanced navigation data through a connected network, upon the request of playback from the user, as described above, according to the playback scenario based on the enhanced navigation data, also along with additional content of the enhanced navigation data, reproduces the content of the loaded disc 1′.

If the identifying information of content is not the same as that in comparison, or directory structure of files having the file names in accordance with the confirmed identification information of content do not exist, the player 500 downloads enhanced navigation data associated with the loaded disc 1′ through a connected network; the data is stored in the memory stick 2 as described above and made available for other players.

According to at least one embodiment of the present invention as described in detail hereinbefore, by storing enhanced navigation data of content recorded in a recording medium into a portable storing means along with link information associating the enhanced navigation data with the content, regardless of change of places or disc players, identical content recorded in a recording medium can be reproduced promptly without the need to newly download the enhanced navigation data.

The present invention is not limited to the foregoing description of preferred embodiments and those skilled in the art will easily appreciate that numerous embodiments with improvements, modifications, substitutions, or additions can be realized within the spirit and scope of the present invention. It is intended that all such improvements, modifications, substitutions, or additions fall within the spirit and scope of the invention as defined by the following appended claims.

What is claimed is:

1. A recording medium, comprising:
a content including at least video data; and
navigation data having information for playback and/or searching the content,
wherein the navigation data includes information for identifying the content.

2. The recording medium of claim 1, wherein the content identifying information includes a content provider ID of the content and a content ID assigned uniquely to the content by the provider.

3. A removable data storage medium, comprising:
a storage area for storing enhanced navigation data having additional information for a content recorded in another medium,
wherein a file structure for linking the enhanced navigation data with the content is recorded in the storage area.

4. The storage medium of claim 3, wherein the file structure has directories named after a provider name and a title to uniquely identify the content, and one of the directories whose name includes a provider name is a parent directory of another of the directories whose name includes a title.

5. The storage medium of claim 3, wherein the file structure is structured such that at least one file which is designated for storing the enhanced navigation data has a file name including a provider name and a title to uniquely identify the content.

6. A method for a player to reproduce a content recorded on a recording medium, comprising:
receiving enhanced navigation data for interactive playback of the content from a server connected to a network;
storing the received enhanced navigation data into an auxiliary storage connected in a removable manner to the player; and
recording information for identifying the content into the auxiliary storage to link the content on the recording medium with the enhanced navigation data in the auxiliary storage.

7. The method of claim 6, wherein the information for identifying the content includes a content provider ID and a content ID assigned uniquely to the content by the provider.

8. The method of claim 6, wherein the information for identifying the content is added to each object constituting the enhanced navigation data.

9. The method of claim 6, wherein the information for identifying the content is obtained from the recording medium or the server.

10. A method for a player to reproduce a content recorded on a recording medium, comprising:
receiving enhanced navigation data for interactive playback of the content from a server connected to a network; and
storing the received enhanced navigation data into an auxiliary storage connected in a removable manner to the player,
wherein the enhanced navigation data is stored such that a file structure accommodating the enhanced navigation data links the enhanced navigation data with the content.

11. The method of claim 10, wherein the file structure has directories named after a provider name and a title to uniquely identify the content, and one of the directories whose name includes a provider name is a parent directory of another of the directories whose name includes a title.

12. The method of claim 11, wherein the provider name and the title for identifying the content uniquely are obtained from the recording medium.

13. The method of claim 10, wherein the file structure is specified from a server which provides the enhanced navigation data.

14. The method of claim 10, wherein the file structure is structured such that at least one file which is designated for storing the enhanced navigation data has a file name including a provider name and a title to uniquely identify the content.

15. A method for a player to reproduce a content recorded on a recording medium, comprising:
reading identifying information of a content recorded on the recording medium;
checking whether enhanced navigation data linked with the read identifying information is stored in an auxiliary storage connected in a removable manner to the player; and
reproducing the content based on the enhanced navigation data stored in the auxiliary storage, if stored.

16. The method of claim 15, wherein the checking step determines whether the linked enhanced navigation data is stored or not, based on whether identifying information identical to the read identifying information is stored in the auxiliary storage.

17. The method of claim 15, wherein the identifying information of a content includes a content provider ID of the content and a content ID assigned uniquely to the content by the provider.

18. The method of claim 17, wherein the checking step determines whether the linked enhanced navigation data is stored or not, based on whether directories named respectively after the provider ID and the content ID are recorded in the auxiliary storage.

19. The method of claim 17, wherein the checking step determines whether the linked enhanced navigation data is stored or not, based on whether files named respectively after the provider ID and content ID are recorded in the auxiliary storage.

20. An apparatus reproducing a content recorded on a recording medium, comprising:
a playback unit for reading and decoding the recorded content;
an interface unit, connected to an external network and an external device, for communicating data; and
a controller that checks whether an auxiliary storage is attached through the interface unit, obtains enhanced navigation data for the content if connected, and stores the enhanced navigation data into the auxiliary storage along with information for linking the enhanced navigation data with the content, or controls the playback unit to reproduce the content based on the enhanced navigation data in the auxiliary storage.

21. The apparatus of claim 20, wherein the linking information is identifying information including a content provider ID of the content and a content ID assigned uniquely to the content by the provider, and the enhanced navigation data includes the linking information.

22. The apparatus of claim 20, wherein the linking information is a file structure having directories or files, the names of which contain a content provider ID of the content and a content ID assigned uniquely to the content by the provider

23. The apparatus of claim 20, wherein, in case that the information for linking with the content recorded on the recording medium is stored in the auxiliary storage, the controller controls the playback unit to reproduce the content based on enhanced navigation data specified by the linking information stored in the auxiliary storage.

24. The apparatus of claim 20, wherein, in case that the information for linking with the content recorded on the recording medium is not stored in the auxiliary storage, the controller obtains the enhanced navigation data from the external network through the interface unit.
